(19) United States
(12) Patent Application Publication
(10) Pub. No.: US 2019/0110304 A1
(43) Pub. Date: Apr. 11, 2019

(54) Wireless Systems and Methods Using Low-Frequency Spectrum for Small Cells and Millimeter Wave Spectrum for Macrocells

(71) Applicant: Phazr, Inc., Allen, TX (US)

(72) Inventor: Farooq Khan, Allen, TX (US)

(21) Appl. No.: 15/726,238

(22) Filed: Oct. 5, 2017

(51) Int. Cl. H04W 72/12; H04W 16/20; H04W 84/00

(52) U.S. Cl. CPC H04W 72/1215; H04W 16/225; H04W 84/005; H04W 16/20

(57) ABSTRACT

A method of forming a small cell coverage area includes receiving millimeter wave band downlink signals having a large subcarrier spacing and transmitting millimeter wave band uplink signals having the large subcarrier spacing. The method includes transmitting sub-7 GHz band downlink signals having a small subcarrier spacing and receiving sub-7 GHz band uplink signals having the small subcarrier spacing. The small cell coverage area is formed using a sub-7 GHz band spectrum. The method includes transmitting the millimeter wave band downlink signals by a macrocell radio base station, and receiving the millimeter wave band downlink signals by a small cell radio base station. The method includes transmitting the sub-7 GHz band downlink signals by the small cell radio base station, and receiving the sub-7 GHz band downlink signals by a communication device.

### BACKGROUND

The invention relates to wireless communications, and in particular relates to wireless systems and methods using sub-7 GHz spectrum for small cells and millimeter wave spectrum above 24 GHz for macrocells.

### DESCRIPTION OF THE RELATED ART

Currently, wireless access methods are based on two popular standards: a wide area network (WAN) standard referred to as The Fourth Generation Long Term Evolution (4G LTE) system; and a local area network (LAN) standard called Wi-Fi. Wi-Fi is generally used indoors as a short-range wireless extension of wired broadband systems. The 4G LTE systems on the other hand provide wide area long-range connectivity both outdoors and indoors using dedicated infrastructure such as cell towers and backhaul to connect to the Internet.

As more people connect to the Internet, increasingly chat with friends and family, watch videos, listen to streamed music, and indulge in virtual or augmented reality, data traffic continues to grow at unprecedented rates. In order to address the continuously growing wireless capacity challenge, the next generation of LAN and WAN systems are relying on higher frequencies referred to as millimeter waves in addition to currently used frequency bands below 6 GHz. The next generation of wireless WAN standard referred to as New Radio (NR) is under development in the Third Generation Partnership Project (3GPP). The 3GPP NR standard supports both sub-7 GHz frequencies as well as millimeter wave bands above 24 GHz. Table 1 provides examples of millimeter wave bands.

TABLE 1
Examples of millimeter wave bands

| | | Frequency | Bandwidth |
|---|---|---|---|
| Bands [GHz] | | [GHz] | [GHz] |
| 24 | GHz Bands | 24.25-24.45 | 0.200 |
| | | 25.05-25.25 | 0.200 |
| LMDS Band | | 27.5-28.35 | 0.850 |
| | | 29.1-29.25 | 0.150 |
| | | 31-31.3 | 0.300 |
| 39 | GHz Band | 38.6-40 | 1.400 |
| 37/42 | GHz Bands | 37.0-38.6 | 1.600 |
| | | 42.0-42.5 | 0.500 |
| 60 | GHz | 57-64 | 7.000 |
| | | 64-71 | 7.000 |
| 70/80 | GHz | 71-76 | 5.000 |
| | | 81-86 | 5.000 |
| 90 | GHz | 92-94 | 2.900 |
| | | 94.1-95.0 | |
| 95 | GHz | 95-100 | 5.000 |
| 105 | GHz | 102-105 | 7.500 |
| | | 105-109.5 | |
| 112 | GHz | 111.8-114.25 | 2.450 |
| 122 | GHz | 122.25-123 | 0.750 |
| 130 | GHz | 130-134 | 4.000 |
| 140 | GHz | 141-148.5 | 7.500 |
| 150/160 | GHz | 151.5-155.5 | 12.50 |
| | | 155.5-158.5 | |
| | | 158.5-164 | |

### SUMMARY

According to disclosed embodiments, a method of forming a small cell coverage area includes receiving millimeter wave band downlink signals having a large subcarrier spacing and transmitting millimeter wave band uplink signals having the large subcarrier spacing. The method includes transmitting sub-7 GHz band downlink signals having a small subcarrier spacing and receiving sub-7 GHz band uplink signals having the small subcarrier spacing. The small cell coverage area is formed using a sub-7 GHz band spectrum.

The method includes transmitting the millimeter wave band downlink signals having the large subcarrier spacing by a macrocell radio base station, and receiving the millimeter wave band downlink signals having the large subcarrier spacing by a small cell radio base station. The method includes transmitting the sub-7 GHz band downlink signals having the small subcarrier spacing by the small cell radio base station, and receiving the sub-7 GHz band downlink signals having the small subcarrier spacing by a communication device.

According to disclosed embodiments, a method of forming a small cell coverage area includes receiving millimeter wave band downlink signals having a large bandwidth and a large subcarrier spacing, and transmitting millimeter wave band uplink signals having the large bandwidth and the large subcarrier spacing. The method includes transmitting sub-7 GHz band downlink signals having a small bandwidth and a small subcarrier spacing, and receiving sub-7 GHz band uplink signals having the small bandwidth and a small subcarrier spacing, wherein the small cell coverage area is formed using a sub-7 GHz band spectrum.

According to disclosed embodiments, a method of forming a small cell coverage area includes receiving by a small cell radio base station millimeter wave band downlink signals, and transmitting by the small cell radio base station millimeter wave band uplink signals. The method includes transmitting by the small cell radio base station sub-7 GHz band downlink signals, and receiving by the small cell radio base station sub-7 GHz band uplink signals, wherein the small cell coverage area is formed using a sub-7 GHz band spectrum. The method includes transmitting the millimeter wave band downlink signals having a large subcarrier spacing by a macrocell radio base station, and receiving the millimeter wave band downlink signals having the large subcarrier spacing by the small cell radio base station. The method includes transmitting the sub-7 GHz band downlink signals having a small subcarrier spacing by the small cell radio base station, and receiving the sub-7 GHz band downlink signals having the small subcarrier spacing by a communication device.

According to disclosed embodiments, a small cell radio base station includes a first transmitter configured to transmit millimeter wave band uplink signals having a large subcarrier spacing, a first receiver configured to receive millimeter wave band downlink signals having the large subcarrier spacing, a second receiver configured to receive sub-7 GHz uplink signals having a small subcarrier spacing, and a second transmitter configured to transmit sub-7 GHz downlink signals having the small subcarrier spacing.

According to disclosed embodiments, the first transmitter includes a first signal processing circuit configured to generate the millimeter wave band uplink signals, a power amplifier configured to amplify the millimeter wave band uplink signals, and a transmit antenna array configured to transmit the millimeter wave band uplink signals.

According to disclosed embodiments, the second transmitter includes a second signal processing circuit configured to generate the sub-7 GHz band downlink signals, a power amplifier configured to amplify the sub-7 GHz band downlink signals, and a transmit antenna array configured to transmit the sub-7 GHz band downlink signals.

According to disclosed embodiments, the first receiver includes an antenna array configured to receive the millimeter wave band downlink signals, a low noise amplifier configured to amplify the millimeter wave band downlink signals, and a third signal processing circuit configured to process the millimeter wave band downlink signals.

According to disclosed embodiments, the second receiver includes an antenna array configured to receive the sub-7 GHz band uplink signals, a low noise amplifier configured to amplify the sub-7 GHz band uplink signals, and a fourth signal processing circuit configured to process the sub-7 GHz band uplink signals.

According to disclosed embodiments, the millimeter wave band signals are transmitted using an Orthogonal Frequency Division Multiple (OFDM) access sub-carrier spacing that is greater than the sub-carrier spacing of the transmitted sub-7 GHz band signals.

According to disclosed embodiments, the millimeter wave band received signals uses an Orthogonal Frequency Division Multiple (OFDM) access sub-carrier spacing that is greater than the sub-carrier spacing used by the received second sub-7 GHz band signal. In OFDM, a large number of closely spaced orthogonal sub-carrier signals are used to carry information. The bandwidth occupied by the transmitted signals is determined by the sub-carrier spacing and the Fast Fourier Transform (FFT) or Inverse Fast Fourier Transform (FFT) size. For example, for a subcarrier spacing of 120 KHz and FFT size, of 1024, the bandwidth occupied will be 122.88 MHz. To match the bandwidth to the available spectrum block such as 100 MHz in this case, some of the subcarriers at the edge of the spectrum may not be used.

### BRIEF DESCRIPTION OF THE DRAWINGS

FIG. 1 illustrates an exemplary wireless system in accordance with disclosed embodiments.

FIGS. 2-3 are block diagrams of a macro-cell, a small cell, and a communication device.

FIG. 4 is a flow diagram of a method for providing a small cell wireless coverage.

FIG. 5 illustrate user planes in a transmitter and a receiver.

FIG. 6-7 illustrate wireless signals according to disclosed embodiments.

FIG. 8 illustrates uplink physical channels, uplink physical signals, downlink physical channels and downlink physical signals according to disclosed embodiments.

### DETAILED DESCRIPTION

According to disclosed embodiments, a wireless communication system uses sub-7 GHz frequency spectrum for small cells and Wi-Fi access points, and millimeter wave frequency spectrum for macro-cell base stations. Small cells and Wi-Fi access point generally provides a coverage range of around one hundred meters while a microcell coverage range can be several hundred meters and in some cases over a kilometer.

The macrocell base stations are connected to a communication network such as the Internet via a wired link (e.g., fiber optic link). The small cells and Wi-Fi access points may not implement wired links and rely on the macrocell base stations to provide a data link to the Internet. The macrocell stations provide large bandwidth using millimeter wave frequency spectrum to create massive wireless capacity in a large coverage area which is then shared by many small cells and Wi-Fi access points.

According to disclosed embodiments, a method provides a Wi-Fi hot spot using sub-7 GHz frequency spectrum which enables communication devices to communicate with a Wi-Fi access point but the Wi-Fi access point relies on a macro-cell base station for wireless connectivity to the Internet over millimeter wave frequency spectrum. Also, according to disclosed embodiments, a method provides a small cell coverage area using sub-7 GHz frequency spectrum which enables communication devices to communicate with a small cell but the small cell relies on a macrocell base station for wireless connectivity to the Internet over millimeter wave frequency spectrum.

According to disclosed embodiments, the macro-cell base stations implement high-gain antenna arrays and use high-power amplifiers to achieve high transmit equivalent isotropically radiated power (EIRP) allowed on the licensed millimeter wave frequency spectrum above 24 GHz. According to some disclosed embodiments, for spectrum bands above 24 GHz for mobile radio services, 75 dBm/100 MHz EIRP (equivalent isotropically radiated power) may be used for base stations for the licensed bands in the 27.5-28.35 GHz, 37-38.6 GHz, and 38.6-40 GHz frequency range. According to some disclosed embodiments, the EIRP for Wi-Fi hotspots in the unlicensed spectrum may be limited to 30 dBm, and for small cells in the sub-7 GHz spectrum, EIRP may be limited to around 30 dBm. It should be noted that when a small cell transmits millimeter wave signals on the uplink towards the macrocell, its EIRP can be higher at levels permitted for the radio base station. The high EIRP levels from the macrocell base stations allow signals to reach over larger distance covering large areas. Consequently, a single macrocell base station can provide wireless links to many small cells and Wi-Fi access points simultaneously. A large-gain beamforming at millimeter wave frequency spectrum is achieved by using a very large number of smaller size antenna elements working coherently. At millimeter wave frequencies, the smaller size of antennas is enabled by carrier waves that are millimeters long compared to centimeter-long waves at sub-7 GHz frequencies.

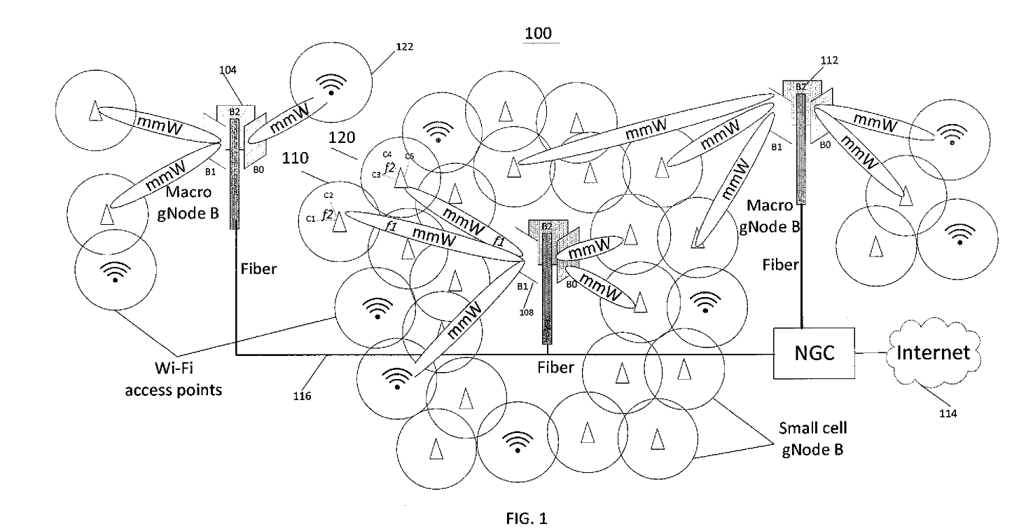

FIG. 1 illustrates an exemplary wireless communication system 100 in accordance with disclosed embodiments. The system 100 includes macro-cell base stations 104, 108 and 112 interconnected via a wired link such as, for example, a fiber optic link 116. The macro-cell base stations 104, 108 and 112 may be connected to a telecommunications network such as the Internet 114. The macro-cells are also referred to as Macro gNode B.

The system 100 includes a plurality of small cells and Wi-Fi access points 110, 120 and 122. The macro-cells 104, 108 and 112 communicate with the small cells and Wi-Fi access points 110, 120 and 122 using millimeter wave spectrum. As shown in FIG. 1, macro-cell 108 communicates with small cells and Wi-Fi access points 110, 120, and 122 using millimeter wave frequency f₁. Thus, the macrocell 108 transmits downlink signals having a millimeter wave frequency f1 to the small cells and Wi-Fi access points 110, 120 and 122 and receives uplink signals having millimeter wave frequency f1 from the small cells and Wi-Fi access points. The small cells and Wi-Fi access points 110, 120 and 122 serve communication devices on sub-7 GHz spectrum. The small cell 110 serves communication devices C1 and C2 in a coverage area on frequency f2 (sub-7 GHz band), and Wi-Fi access point 120 serves communication devices C3, C4 and C5 in a coverage area on frequency f2. The communication devices may, for example, be smartphones, laptop computers, desktop computers, augmented reality/virtual reality (AR/VR) devices or any other communication devices. Thus, the system 100 uses sub-7 GHz spectrum for small cells and Wi-Fi access points and millimeter wave frequency spectrum for macrocells.

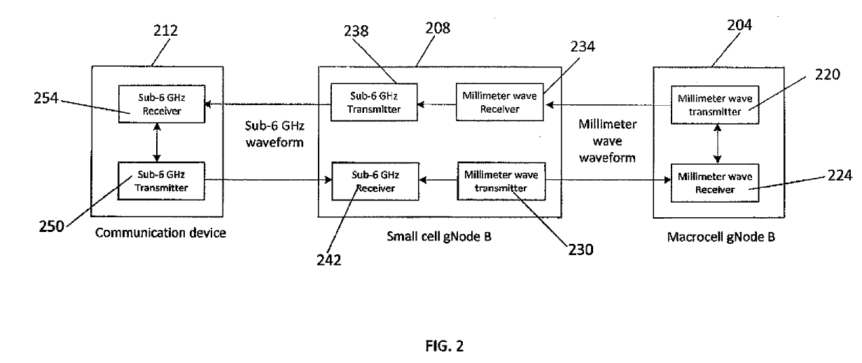

FIG. 2 is a block diagram of transmit and receive chains in a macrocell 204, a small cell 208, and a communication device 212 according to disclosed embodiments. A physical layer waveform optimized for millimeter wave frequency spectrum is used for communication between the macrocell 204 and the small cell 208 while a physical layer waveform optimized for sub-7 GHz frequency spectrum is used for communication between the small cell 208 and the communication device 212.

According to disclosed embodiments, a physical layer waveform optimized for millimeter wave frequency spectrum may, for example, use a larger bandwidth and larger sub-carrier spacing in Orthogonal Frequency Division Multiple (OFDM) access compared to the bandwidth and sub-carrier spacing used for the sub-7 GHz frequency spectrum. For example, a waveform optimized for millimeter wave frequency spectrum may use, for example, 120 KHz-480 KHz range, 120 KHz, 240 KHz or 480 KHz sub-carrier spacing while a waveform optimized for sub-7 GHz frequency spectrum may use, for example, 15 KHz-60 KHz range, 15 KHz, 30 KHz or 60 KHz sub-carrier spacing. A larger sub-carrier spacing provides robustness against elevated phase noise and other degradations typically experienced at millimeter wave frequencies. Moreover, a waveform optimized for millimeter wave frequency may support large multi-user MIMO (Multiple Input Multiple Output) order such as the case for massive MIMO to provide beamforming and spatial multiplexing from the macrocell 204 towards a large number of small cells. A physical layer waveform optimized for sub-7 GHz frequency spectrum may not need to support very large MIMO orders to reduce complexity both at the small cell 208 and the communication devices.

Referring to FIG. 2, the macrocell 204 includes a millimeter wave transmitter 220 and a millimeter wave receiver 224 for communication over the millimeter wave spectrum. The small cell 208 includes a millimeter wave transmitter 230 and a millimeter wave receiver 234 for communication with the macrocell 204. The small cell 208 also includes a sub-7 GHz transmitter 238 and a sub-7 GHz receiver 242 for communication with the communication device 212. The communication device 212 includes a sub-7 GHz transmitter 250 and a sub-7 GHz receiver 254 for communication with the small cell 208.

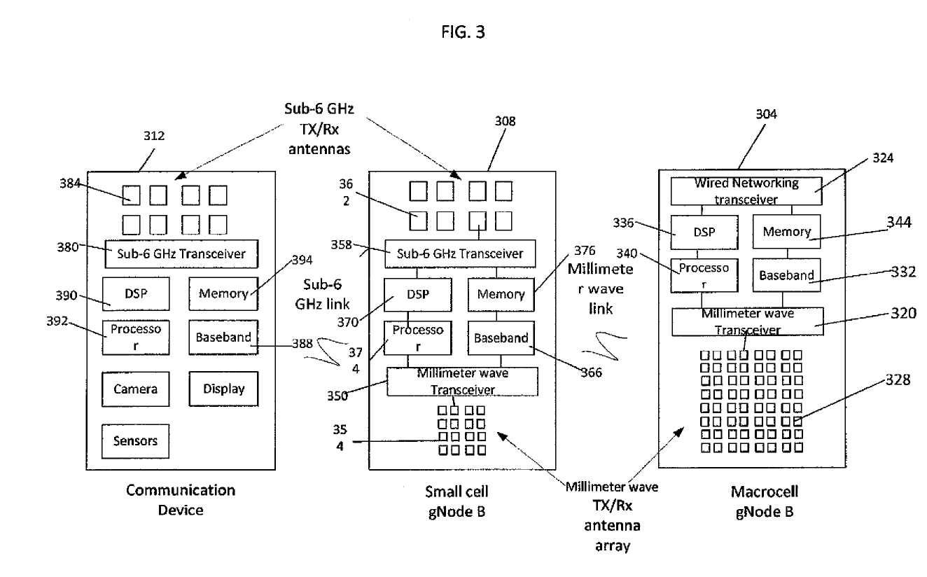

FIG. 3 is a block diagram of components in a macrocell 304, a small cell 308, and a communication device 312. The macrocell 304 includes a millimeter wave transceiver 320, a wired network transceiver 324 and a millimeter wave antenna array 328 at one or more of the licensed bands such as 28, 37 and 39 GHz licensed bands for communication over the millimeter wave spectrum. The macrocell 304 also includes a baseband processor 332, a digital signal processor (DSP) 336, a communications protocol processor 340, a memory 344. The macrocell 304 may also implement other networking and routing functions.

The small cell 308 includes a millimeter wave transceiver 350 and a millimeter wave antenna array 354 at one or more of the licensed bands such as 28, 37 and 39 GHz licensed bands for communication with the macrocell 304 over the millimeter wave spectrum. The small cell 308 also implements a sub-7 GHz transceiver 358 and an antenna array 362 for communication with the communication device 312 over the sub-7 GHz spectrum. The small cell 312 also includes a baseband processor 366, a digital signal processor (DSP) 370, a communications protocol processor 374, and a memory 376. The small cell 308 may implement other networking and routing functions.

The communication device 312 includes a sub-7 GHz transceiver 380 and antennas 384 for communication with the small cell 308 over sub-7 GHz spectrum. The communication device 312 also includes a baseband processor 388, a digital signal processor (DSP) 390, a communications protocol processor 392, and a memory 394. The communication device 312 may implement other networking functions. The communication device may also include additional functionalities such as various sensors, a display and a camera.

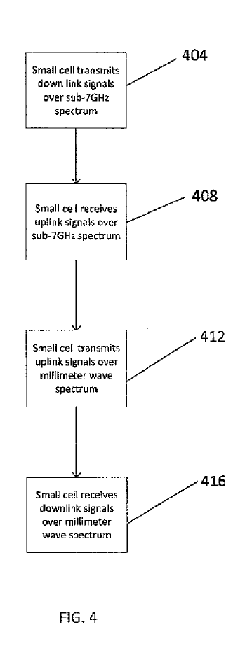

FIG. 4 is a flow diagram of a method for providing a small cell wireless coverage while relying on millimeter wave spectrum for wireless backhaul according to disclosed embodiments. In a step 404, a small cell transmits downlink signals to communication devices over sub-7 GHz frequency spectrum. In a step 408, the small cell receives uplink signals from the communication devices over sub-6 GHz frequency spectrum. Thus, the small cell creates a wireless coverage area relying on sub-7 GHz frequency spectrum which enables the communication devices in the small cell coverage area to communicate. In a step 412, the small cell transmits uplink signals to a macrocell over millimeter wave frequency spectrum. In a step 416, the small cell receives downlink signals from the macrocell over millimeter wave frequency spectrum. Thus, the small cell relies on the macrocell for wireless connectivity to the Internet over millimeter wave frequency spectrum. A Wi-Fi access point uses the aforementioned method to provide a Wi-Fi hot spot.

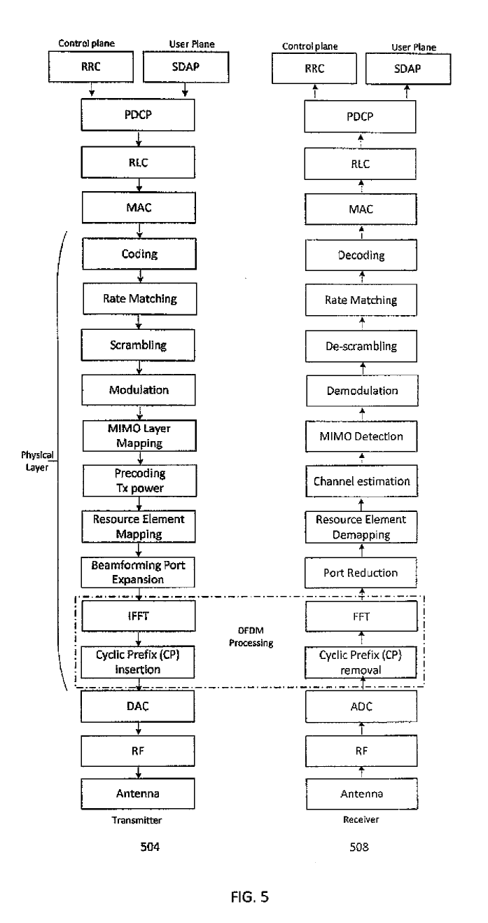

FIG. 5 illustrate user plane and control plane in a transmitter 504 and in a receiver 508 according to some disclosed embodiments. The transmitter 504 includes, among others, a physical layer, a Medium Access Control (MAC), a Radio Link Control (RLC), and a Packet Data Convergence Protocol (PDCP). The user plane also includes a SDAP (Service Data Adaptation Protocol) and a Radio Resource Control (RRC) sitting on top of the PDCP layer.

At the transmitter 504, OFDM processing is performed as part of the Physical layer before digital-to-analog (DAC) conversion in the transmitter, and at the receiver 508 OFDM processing is performed after analog-to-digital conversion (ADC). As part of the OFDM processing at the transmitter 504, an Inverse Fast Fourier Transform (IFFT) operation is performed and a cyclic prefix (CP) is added to the transformed symbols. As part of the OFDM processing at the receiver 508, cyclic prefix (CP) is removed and a Fast Fourier Transform (FFT) operation is performed to generate the modulation symbols. The number of sub-carriers in an OFDM system is equal to the IFFT/FFT size. For a fixed total bandwidth, a larger IFFT/FFT size generates a smaller sub-carrier spacing while a smaller IFFT/FFT size will generate a larger sub-carrier spacing. Therefore, the sub-carrier spacing can be adjusted by changing the size of the IFFT/FFT.

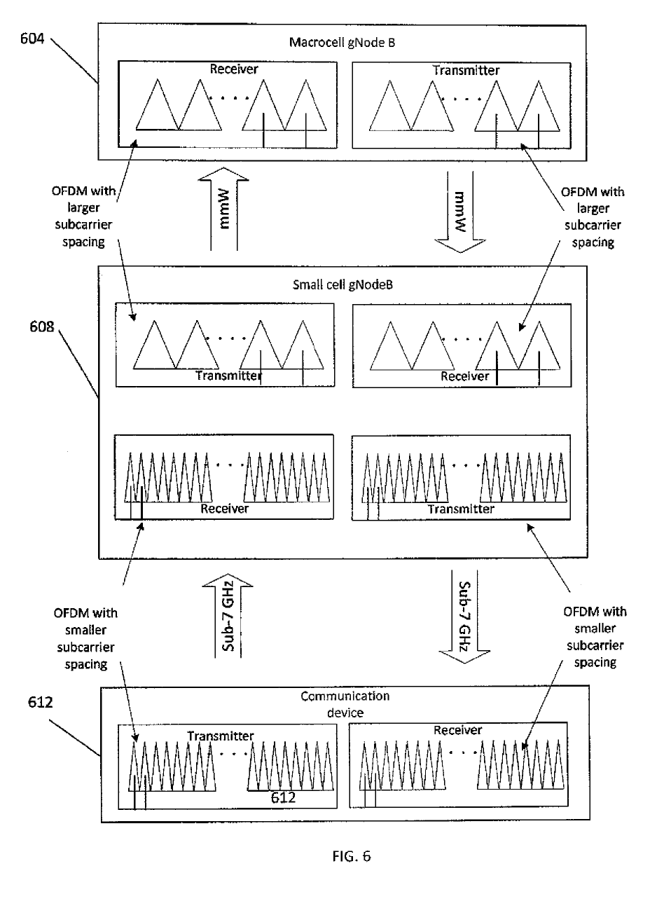

FIG. 6 illustrates wireless signals exchanged between a macrocell 604 and a small cell 608 and between the small cell 608 and a communication device 612 according to some disclosed embodiments. The macrocell 604 transmits signals to the small cell 608 in the millimeter wave spectrum using OFDM with a larger subcarrier spacing (e.g., 120 KHz-480 KHz range). The small cell 608 processes the received signals from the macrocell 604 using OFDM with a larger subcarrier spacing (e.g., 120 KHz-480 KHz range). The small cell 608 transmits signals to the communication device 612 in the sub-7 GHz spectrum using OFDM with a smaller subcarrier spacing (e.g., 15 KHz-60 KHz range). The communication device 612 processes the received signals from the small cell 608 using OFDM with a smaller subcarrier spacing (e.g., 15 KHz-60 KHz range). The communication device 612 transmits signals to the small cell 608 in the sub-7 GHz spectrum using OFDM with a smaller subcarrier spacing. The small cell 608 processes the received signals from the communication device 612 using OFDM with a smaller subcarrier spacing. The small cell 608 transmits signals to the macrocell 604 in the millimeter wave spectrum using OFDM with a larger subcarrier spacing. The macrocell 604 processes the received signals from the small cell 608 using OFDM with a larger subcarrier spacing.

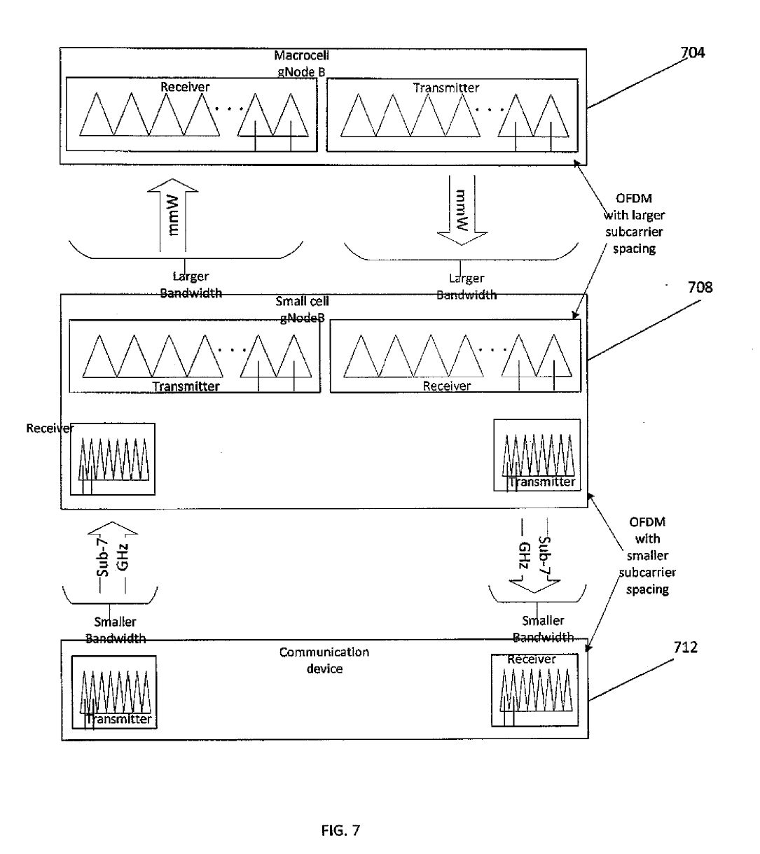

FIG. 7 illustrates wireless signals exchanged between a macrocell 704 and a small cell 708 and between the small cell 708 and a communication device 712 according to other disclosed embodiments. The macrocell 704 transmits signals to the small cell 708 in the millimeter wave spectrum using OFDM with a larger subcarrier spacing (e.g., 120 KHz-480 KHz range) and a larger bandwidth (e.g., 200 MHz-800 MHz range). The small cell 708 processes the received signals from the macrocell 704 using OFDM with a larger subcarrier spacing and a larger bandwidth. The small cell 708 transmits signals to the communication device 712 in the sub-7 GHz spectrum using OFDM with a smaller subcarrier spacing such as, for example, 15 KHz-60 KHz range and a smaller bandwidth such as, for example, 100 MHz or less. The communication device 712 processes the received signals from the small cell 708 using OFDM with a smaller subcarrier spacing such as, for example, 15 KHz-60 KHz range and a smaller bandwidth such as, for example, 100 MHz or less. The communication device 712 transmits signals to the small cell 708 in the sub-7 GHz spectrum using OFDM with a smaller subcarrier spacing such as, for example, 15 KHz-60 KHz range and a smaller bandwidth such as, for example, 100 MHz or less. The small cell 708 processes the received signals from the communication device 712 using OFDM with a smaller subcarrier spacing such as, for example, 15 KHz-60 KHz range and a smaller bandwidth such as, for example, 100 MHz or less. The small cell 708 transmits signals to the macrocell 704 in the millimeter wave spectrum using OFDM with a larger subcarrier spacing such as, for example, 120 KHz-480 KHz range and a larger bandwidth such as, for example, 200 MHz-800 MHz range. The macrocell 704 processes the received signals from the small cell 708 using OFDM with a larger subcarrier spacing such as, for example, 120 KHz-480 KHz range, and a larger bandwidth such as, for example, 200 MHz-800 MHz range.

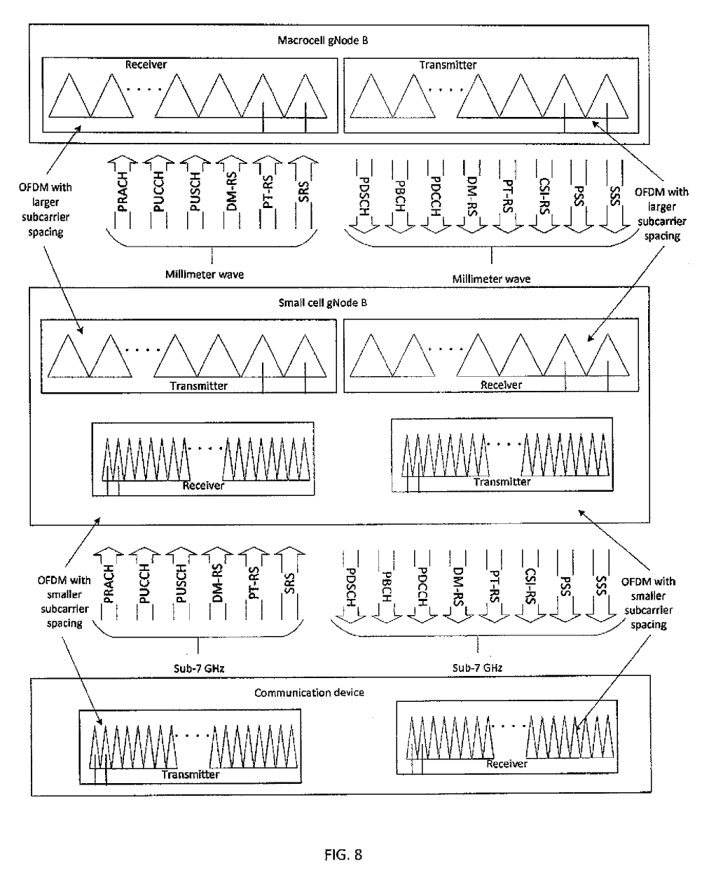

FIG. 8 illustrates uplink physical channels and uplink physical signals transmission and reception, and downlink physical channels and downlink physical signals transmission and reception according to disclosed embodiments. An uplink physical channel corresponds to a set of resource elements carrying information originating from higher layers. The uplink physical channels transmitted from a communication device on sub-7 GHz spectrum with a smaller sub-carrier spacing such as, for example, 15 KHz-60 KHz range and received by a small cell on sub-7 GHz spectrum with a smaller sub-carrier spacing such as, for example, 15 KHz-60 KHz range, includes: Physical Uplink Shared Channel (PUSCH), Physical Uplink Control Channel (PUCCH), Physical Random Access Channel (PRACH). An uplink physical signal is used by the physical layer but does not carry information originating from higher layers. The uplink physical signals transmitted from the communication device on sub-7 GHz spectrum with a smaller sub-carrier spacing such as, for example, 15 KHz-60 KHz range and received by the small cell on sub-7 GHz spectrum with a smaller sub-carrier spacing such as, for example, 15 KHz-60 KHz range, includes: Demodulation reference signals (DM-RS), Phase-tracking reference signals (PT-RS) and Sounding reference signal (SRS).

The uplink physical channels transmitted from the small cell on millimeter wave spectrum with a larger sub-carrier spacing such as, for example, 120 KHz-480 KHz range, and received by a macrocell on millimeter wave spectrum with a larger sub-carrier spacing such as, for example, 120 KHz-480 KHz range, includes: Physical Uplink Shared Channel (PUSCH), Physical Uplink Control Channel (PUCCH), Physical Random Access Channel (PRACH). The uplink physical signals transmitted from the small cell on millimeter wave spectrum with a larger sub-carrier spacing such as, for example, 120 KHz-480 KHz range and received by the macrocell on millimeter wave spectrum with a larger sub-carrier spacing such as, for example, 120 KHz-480 KHz range includes: Demodulation reference signals (DM-RS), Phase-tracking reference signals (PT-RS) and Sounding reference signal (SRS).

A downlink physical channel corresponds to a set of resource elements carrying information originating from higher layers. The downlink physical channels transmitted from the macrocell on millimeter wave spectrum with a larger sub-carrier spacing such as, for example, 120 KHz-480 KHz range and received by the small cell on the millimeter wave spectrum with a larger sub-carrier spacing such as, for example, 120 KHz-480 KHz range includes: Physical Downlink Shared Channel (PDSCH), Physical Broadcast Channel (PBCH) and Physical Downlink Control Channel (PDCCH). A downlink physical signal corresponds to a set of resource elements used by the physical layer but does not carry information originating from higher layers. The downlink physical signals transmitted from the macrocell on millimeter wave spectrum with a larger sub-carrier spacing such as, for example, 120 KHz-480 KHz range and received by the small cell on the millimeter wave spectrum with a larger sub-carrier spacing such as, for example, 120 KHz-480 KHz range includes: Demodulation reference signals (DM-RS), Phase-tracking reference signals (PT-RS) Channel-state information reference signal (CSI-RS) Primary synchronization signal (PSS) and Secondary synchronization signal (SSS).

The downlink physical channels transmitted from the small cell on sub-7 GHz spectrum with a smaller sub-carrier spacing such as, for example, 15 KHz-60 KHz range and received by the communication device on sub-7 GHz spectrum with a smaller sub-carrier spacing such as, for example, 15 KHz-60 KHz range includes: Physical Downlink Shared Channel (PDSCH), Physical Broadcast Channel (PBCH) and Physical Downlink Control Channel (PDCCH). The downlink physical signals transmitted from the small cell on sub-7 GHz spectrum with a smaller sub-carrier spacing such as, for example, 15 KHz-60 KHz range and received by the communication device on sub-7 GHz spectrum with a smaller sub-carrier spacing such as, for example, 15 KHz-60 KHz range includes: Demodulation reference signals (DM-RS), Phase-tracking reference signals (PT-RS) Channel-state information reference signal (CSI-RS) Primary synchronization signal (PSS) and Secondary synchronization signal (SSS).

According to some embodiments, the total bandwidth occupied between a macrocell and a small cell by the downlink channels and downlink signals using larger sub-carrier spacing on millimeter wave spectrum can be the same as the total bandwidth occupied between small cell and communication device by the downlink channels and downlink signals using smaller sub-carrier spacing on the sub-7 GHz spectrum. For example, the total bandwidth occupied between a macrocell and a small cell by the downlink channels and downlink signals using larger sub-carrier spacing on millimeter wave spectrum and the total bandwidth occupied between small cell and communication device by the downlink channels and downlink signals using smaller sub-carrier spacing on the sub-7 GHz spectrum can be 100 MHz. In other embodiments, the total bandwidth occupied between the macrocell and the small cell in the downlink channels and downlink signals using larger sub-carrier spacing such as, for example, 120 KHz-480 KHz range on millimeter wave spectrum can be larger compared the total bandwidth occupied between the small cell and the communication device by the downlink channels and downlink signals using smaller sub-carrier spacing such as, for example, 15 KHz-60 KHz range on the sub-7 GHz spectrum. For example, the total bandwidth occupied between a macrocell and a small cell by the downlink channels and downlink signals using larger sub-carrier spacing on millimeter wave spectrum can be 400 MHz while the total bandwidth occupied between small cell and communication device by the downlink channels and downlink signals using smaller sub-carrier spacing on the sub-7 GHz spectrum can be 100 MHz.

According to some disclosed embodiments, the total bandwidth occupied between the macrocell and the small cell by the uplink channels and uplink signals using larger sub-carrier spacing on millimeter wave spectrum can be the same as the total bandwidth occupied between small cell and the communication device by the uplink channels and uplink signals using smaller sub-carrier spacing on the sub-7 GHz spectrum. For example, the total bandwidth occupied between the macrocell and the small cell by the uplink channels and uplink signals using larger sub-carrier spacing on millimeter wave spectrum can be 400 MHz while the total bandwidth occupied between small cell and the communication device by the uplink channels and uplink signals using smaller sub-carrier spacing on the sub-7 GHz spectrum can be 100 MHz. In other embodiments, the total bandwidth occupied between the macrocell and the small cell by the uplink channels and uplink signals using larger sub-carrier spacing on millimeter wave spectrum can be larger compared the total bandwidth occupied between small cell and the communication device by the uplink channels and uplink signals using smaller sub-carrier spacing on the sub-7 GHz spectrum. For example, the total bandwidth occupied between the macrocell and the small cell by the uplink channels and uplink signals using larger sub-carrier spacing on millimeter wave spectrum can be 400 MHz compared the total bandwidth of 100 MHz occupied between small cell and the communication device by the uplink channels and uplink signals using smaller sub-carrier spacing on the sub-7 GHz spectrum.

According to disclosed embodiments, a macrocell radio base station includes a transmitter configured to transmit a first millimeter wave band signal at a high transmit equivalent isotropically radiated power (EIRP). The transmitter includes a first signal processing circuit configured to generate the first millimeter wave band signal and a power amplifier configured to amplify the first millimeter wave band signal. The transmitter also includes a high gain transmit antenna array configured to transmit the first millimeter wave band signal. The radio base station also includes a receiver configured to receive a second millimeter wave band signal. The receiver also includes a high receive gain antenna array configured to receive the second millimeter wave band signal and a low noise amplifier configured to amplify the second millimeter wave band signal. The receiver also includes a second signal processing circuit configured to process the second millimeter wave band signal.

According to some disclosed embodiments, the first millimeter wave band signal, and the second millimeter wave band signal can be time-division duplexed (TDD) on the same millimeter wave band or frequency-division duplexed (FDD) on two different millimeter wave bands.

According to some disclosed embodiments, the high gain transmit antenna array is a multiple input multiple output (MIMO) transmit antenna array configured to transmit multiple spatial streams in the licensed millimeter wave spectrum, and the high receive gain antenna array is a multiple input multiple output receive antenna array configured to receive multiple spatial streams in the millimeter wave spectrum.

According to some disclosed embodiments, the small cell radio base station millimeter wave and sub-7 GHz transmit antennas are multiple input multiple output (MIMO) transmit antenna arrays configured to transmit multiple spatial streams in the licensed millimeter wave spectrum and sub-7 GHz spectrum, and the small cell radio base station millimeter wave and sub-7 GHz receive antennas are multiple input multiple output (MIMO) receive antenna arrays configured to receive multiple spatial streams in the licensed millimeter wave spectrum and sub-7 GHz spectrum.

According to disclosed embodiments, a communication device includes a transmitter configured to transmit a first signal in the sub-7 GHz band. The transmitter includes a first signal processing circuit configured to generate the first sub-7 GHz band signal and a power amplifier configured to amplify the first sub-7 GHz band signal. The transmitter also includes a transmit antenna configured to transmit the first sub-7 GHz band signal. The communication device also includes a receiver configured to receive a second sub-7 GHz band signal. The receiver also includes a high receive gain antenna array configured to receive the second sub-7 GHz band signal and a low noise amplifier configured to amplify the second sub-7 GHz band signal. The receiver also includes a second signal processing circuit configured to process the second sub-7 GHz band signal.

According to some disclosed embodiments, the first sub-7 GHz band signal, and the second sub-7 GHz band signal can be time-division duplexed (TDD) on the same sub-7 GHz frequency band or frequency-division duplexed (FDD) on two different sub-7 GHz frequency bands.

According to some disclosed embodiments, the communication device sub-7 GHz transmit antennas are multiple input multiple output (MIMO) transmit antennas configured to transmit multiple spatial streams in the sub-7 GHz spectrum, and the communication device sub-7 GHz receive antennas are multiple input multiple output (MIMO) receive antennas configured to receive multiple spatial streams in the sub-7 GHz spectrum.

According to disclosed embodiments, a method includes generating, by a macrocell radio base station, a first millimeter wave band signal and amplifying the first millimeter wave band signal. The method includes transmitting to a small cell radio base station on a licensed millimeter wave band, by the macrocell radio base station, the first millimeter wave band signal using a multiple input multiple output transmit antenna array. The method includes receiving by the macrocell radio base station, from a small cell radio base station, a second millimeter wave band signal using a multiple input multiple output receive antenna array and amplifying and processing the second millimeter wave band signal.

According to disclosed embodiments, a method includes generating, by a small cell radio base station, a first millimeter wave band signal and amplifying the first millimeter wave band signal. The method includes transmitting to a macrocell cell radio base station on a licensed millimeter wave band, by the small cell radio base station, the first millimeter wave band signal using a multiple input multiple output transmit antenna array. The method includes receiving by the small cell radio base station, from a macrocell radio base station, a second millimeter wave band signal using a multiple input multiple output receive antenna array and amplifying and processing the second millimeter wave band signal.

According to disclosed embodiments, a method includes generating, by a small cell radio base station, a first sub-7 GHz band signal and amplifying the first sub-7 GHz band signal. The method includes transmitting to a communication device on a sub-7 GHz band, by the small cell radio base station, the first sub-7 GHz band signal using a multiple input multiple output transmit antenna array. The method includes receiving by the small cell radio base station, a second sub-7 GHz band signal using a multiple input multiple output receive antenna array and amplifying and processing the second sub-7 GHz band signal.

According to disclosed embodiments, a method includes generating, by a communication device, a first sub-7 GHz band signal and amplifying the first sub-7 GHz band signal. The method includes transmitting to a small cell radio base station on a sub-7 GHz band, by the communication device, the first sub-7 GHz band signal using a multiple input multiple output transmit antenna array. The method includes receiving by the communication device, from a small cell radio base station, a second sub-7 GHz band signal using a multiple input multiple output receive antenna array and amplifying and processing the second sub-7 GHz band signal.

According to some disclosed embodiments, baseband functions may be implemented in an application-specific integrated circuit (ASIC) system-on-a-chip (SoC), in general-purpose processors or in field-programmable gate array (FPGA) integrated circuits.

Those skilled in the art will recognize that, for simplicity and clarity, the full structure and operation of all systems suitable for use with the present disclosure is not being depicted or described herein. Instead, only so much of a system as is unique to the present disclosure or necessary for an understanding of the present disclosure is depicted and described. The remainder of the construction and operation of the disclosed systems may conform to any of the various current implementations and practices known in the art.

Of course, those of skill in the art will recognize that, unless specifically indicated or required by the sequence of operations, certain steps in the processes described above may be omitted, performed concurrently or sequentially, or performed in a different order. Further, no component, element, or process should be considered essential to any specific claimed embodiment, and each of the components, elements, or processes can be combined in still other embodiments.

It is important to note that while the disclosure includes a description in the context of a fully functional system, those skilled in the art will appreciate that at least portions of the mechanism of the present disclosure are capable of being distributed in the form of instructions contained within a machine-usable, computer-usable, or computer-readable medium in any of a variety of forms, and that the present disclosure applies equally regardless of the particular type of instruction or signal bearing medium or storage medium utilized to actually carry out the distribution. Examples of machine usable/readable or computer usable/readable mediums include: nonvolatile, hard-coded type mediums such as read only memories (ROMs) or erasable, electrically programmable read only memories (EEPROMs), and user-recordable type mediums such as floppy disks, hard disk drives and compact disk read only memories (CD-ROMs) or digital versatile disks (DVDs).

1. A method of forming a small cell coverage area, comprising:
receiving millimeter wave band downlink signals having a large subcarrier spacing;
transmitting millimeter wave band uplink signals having the large subcarrier spacing;
transmitting sub-7 GHz band downlink signals having a small subcarrier spacing;
receiving sub-7 GHz band uplink signals having the small subcarrier spacing, wherein the small cell coverage area is formed using a sub-7 GHz band spectrum.

2. The method of claim 1, further comprising:
transmitting the millimeter wave band downlink signals having the large subcarrier spacing by a macrocell radio base station;
receiving the millimeter wave band downlink signals having the large subcarrier spacing by a small cell radio base station.

3. The method of claim 1, further comprising:
transmitting the sub-7 GHz band downlink signals having the small subcarrier spacing by the small cell radio base station;
receiving the sub-7 GHz band downlink signals having the small subcarrier spacing by a communication device.

4. A method of forming a small cell coverage area, comprising:
receiving millimeter wave band downlink signals having a large bandwidth and a large subcarrier spacing;
transmitting millimeter wave band uplink signals having the large bandwidth and the large subcarrier spacing;
transmitting sub-7 GHz band downlink signals having a small bandwidth and a small subcarrier spacing;
receiving sub-7 GHz band uplink signals having the small bandwidth and a small subcarrier spacing, wherein the small cell coverage area is formed using a sub-7 GHz band spectrum.

5. The method of claim 4, further comprising:
transmitting the millimeter wave band downlink signals having the large bandwidth and the large subcarrier spacing by a macrocell radio base station;
receiving the millimeter wave band downlink signals having the large bandwidth and the large subcarrier spacing by a small cell radio base station.

6. The method of claim 4, further comprising:
transmitting the sub-7 GHz band downlink signals having the small bandwidth and the small subcarrier spacing by the small cell radio base station;
receiving the sub-7 GHz band downlink signals having the small bandwidth and the small subcarrier spacing by a communication device.

7. A method of forming a small cell coverage area, comprising:
receiving by a small cell radio base station millimeter wave band downlink signals;
transmitting by the small cell radio base station millimeter wave band uplink signals;
transmitting by the small cell radio base station sub-7 GHz band downlink signals;
receiving by the small cell radio base station sub-7 GHz band uplink signals, wherein the small cell coverage area is formed using a sub-7 GHz band spectrum.

8. The method of claim 7, further comprising:
transmitting the millimeter wave band downlink signals having a large subcarrier spacing by a macrocell radio base station;
receiving the millimeter wave band downlink signals having the large subcarrier spacing by the small cell radio base station.

9. The method of claim 7, further comprising:
transmitting the sub-7 GHz band downlink signals having a small subcarrier spacing by the small cell radio base station;
receiving the sub-7 GHz band downlink signals having the small subcarrier spacing by a communication device.

10. A method of forming a Wi-Fi hotspot area, comprising:
receiving millimeter wave band downlink signals having a large subcarrier spacing;
transmitting millimeter wave band uplink signals having the large subcarrier spacing;
transmitting sub-7 GHz band downlink signals having a small subcarrier spacing;
receiving sub-7 GHz band uplink signals having the small subcarrier spacing, wherein the Wi-Fi hotspot area is formed using a sub-7 GHz band spectrum.

11. The method of claim 10, further comprising:
transmitting the millimeter wave band downlink signals having the large subcarrier spacing by a macrocell radio base station;
receiving the millimeter wave band downlink signals having the large subcarrier spacing by a Wi-Fi access point.

12. The method of claim 10, further comprising:
transmitting the sub-7 GHz band downlink signals having the small subcarrier spacing by the Wi-Fi access point;
receiving the sub-7 GHz band downlink signals having the small subcarrier spacing by a communication device.

13. The method of claim 10, further comprising:
receiving the millimeter wave band downlink signals having a large bandwidth by the Wi-Fi access point;
transmitting the millimeter wave band uplink signals having the large bandwidth by the Wi-Fi access point;
transmitting the sub-7 GHz band downlink signals having a small bandwidth by the Wi-Fi access point;
receiving the sub-7 GHz band uplink signals having the small bandwidth by the Wi-Fi access point.

14. A small cell radio base station, comprising:
a first transmitter configured to transmit millimeter wave band uplink signals having a large subcarrier spacing;
a first receiver configured to receive millimeter wave band downlink signals having the large subcarrier spacing;
a second receiver configured to receive sub-7 GHz uplink signals having a small subcarrier spacing;
a second transmitter configured to transmit sub-7 GHz downlink signals having the small subcarrier spacing.

15. The small cell radio base station of claim 14, wherein the first transmitter comprises:
a first signal processing circuit configured to generate the millimeter wave band uplink signals;
a power amplifier configured to amplify the millimeter wave band uplink signals;
a transmit antenna array configured to transmit the millimeter wave band uplink signals.

16. The small cell radio base station of claim 14, wherein the second transmitter comprises:
a second signal processing circuit configured to generate the sub-7 GHz band downlink signals;
a power amplifier configured to amplify the sub-7 GHz band downlink signals;
a transmit antenna array configured to transmit the sub-7 GHz band downlink signals.

17. The small cell radio base station of claim 14, wherein the first receiver comprises:
an antenna array configured to receive the millimeter wave band downlink signals;
a low noise amplifier configured to amplify the millimeter wave band downlink signals;
a third signal processing circuit configured to process the millimeter wave band downlink signals.

18. The small cell radio base station of claim 14, wherein the second receiver comprises:
an antenna array configured to receive the sub-7 GHz band uplink signals;
a low noise amplifier configured to amplify the sub-7 GHz band uplink signals;
a fourth signal processing circuit configured to process the sub-7 GHz band uplink signals.

19. The small cell radio base station of claim 14, wherein the millimeter wave band signals are transmitted using an Orthogonal Frequency Division Multiple (OFDM) access sub-carrier spacing that is greater than the sub-carrier spacing of the transmitted sub-7 GHz band signals.

20. The small cell radio base station of claim 14, wherein the millimeter wave band received signals uses an Orthogonal Frequency Division Multiple (OFDM) access sub-carrier spacing that is greater than the sub-carrier spacing used by the received second sub-7 GHz band signal.

21. The small cell radio base station of claim 14, wherein the millimeter wave band signals are transmitted using a signal bandwidth which is greater than the signal bandwidth used by the transmitted sub-7 GHz band signals.

22. The small cell radio base station of claim 14, wherein the received bandwidth of the millimeter wave band signals is greater than the signal bandwidth of the sub-7 GHz band signals received.
